(19) United States
(12) Patent Application Publication
(10) Pub. No.: US 2024/0252972 A1
(43) Pub. Date: Aug. 1, 2024

(54) FILTER ELEMENT AND FILTER SYSTEM

(71) Applicant: MANN+HUMMEL GmbH, Ludwigsburg (DE)

(72) Inventors: Philipp HETTKAMP, Steinheim (DE); Markus WAGNER, Arnstorf (DE); Michael KAUFMANN, Meckenheim (DE)

(21) Appl. No.: 18/634,455

(22) Filed: Apr. 12, 2024

Related U.S. Application Data
(63) Continuation of application No. PCT/EP2022/078105, filed on Oct. 10, 2022.

(30) Foreign Application Priority Data
Oct. 15, 2021 (DE) 102021126855.9

(51) Int. Cl. B01D 46/52; B01D 45/16; B01D 46/00; B01D 50/20

(52) U.S. Cl. CPC B01D 46/523; B01D 45/16; B01D 46/0002; B01D 50/20; B01D 2265/04; B01D 2271/027

(57) ABSTRACT

A filter element for filtering fluid has a filter bellows with a zigzag folded filter medium arranged in a reinforcement frame. A seal is arranged at least partially continuously at least in section at a circumferential side of the filter medium at a raw side inlet surface or clean side outlet surface of the filter bellows. Elongate adhesive sections are arranged along an unwinding of folds of the filter medium in adhesive tracks at an inflow side or outflow side, or both, of the folds. The adhesive tracks at the inflow side and outflow side are arranged offset in transverse direction of the filter medium. At least the adhesive tracks at the outflow side are designed to relieve tension for a length change compensation of the adhesive tracks at the outflow side in relation to filter medium and/or seal. A filter system with such a filter element is provided.

### CROSS-REFERENCE TO RELATED APPLICATIONS

This application is a continuation application of international application No. PCT/EP2022/078105 having an international filing date of Oct. 10, 2022, and designating the United States, the international application claiming a priority date of Oct. 15, 2021, based on prior filed German patent application No. 10 2021 126 855.9, the entire contents of the aforesaid international application and the aforesaid German patent application being incorporated herein by reference.

### BACKGROUND

The invention concerns a filter element for filtering a fluid, in particular for use as an air filter of an internal combustion engine or as an interior air filter, in particular of a motor vehicle, as well as a filter system with a filter element.

DE 10 2009 040 202 A1 discloses a filter comprising an accordion-like folded filter medium which separates a raw side from a clean side and comprises alternating fold tips and fold bases. In the intermediate spaces of the folds, adhesive tracks are arranged which extend alternatingly between fold tips and fold bases, wherein at least two adhesive tracks are arranged parallel to each other and perpendicularly to the direction of the fold tips on the filter element at the raw side as well as at the clean side of the filter medium, respectively. The adhesive tracks at the raw side and/or at the clean side are interrupted in regular spacings, wherein the starting and end points of the gaps of the adhesive tracks are aligned along a plurality of straight lines which extend parallel to each other and extend relative to the fold tips at an angle of 10° to 80°, preferably 45°+/−15°.

### SUMMARY

An object of the invention is providing an improved filter element for filtering a fluid which has a long service life while providing high reliability in operation.

A further object is providing a filter system for filtering a fluid for accommodating such an exchangeable filter element.

The aforementioned object is solved according to an aspect of the invention by a filter element for filtering a fluid, in particular air, with at least one filter bellows with a zigzag-shaped folded filter medium, with a raw side inlet surface and a clean side outlet surface, wherein the filter bellows is arranged in a reinforcement frame, with at least one seal which is arranged circumferentially at least partially continuously at least in sections at an outer circumferential side of the filter medium at the inlet surface or at the outlet surface of the filter bellows, in particular is connected by foaming or molding to the reinforcement frame, wherein at an inflow side and/or at an outflow side of folds of the filter bellows a plurality of elongate adhesive sections are arranged along an unwinding of the folds of the filter medium in at least two adhesive tracks, wherein adhesive tracks at the inflow side and adhesive tracks at the outflow side are arranged offset relative to each other in a transverse direction, wherein adhesive tracks at least in sections are configured so as to relieve tension for compensation of a length change of the adhesive tracks in relation to the filter medium and/or the seal.

The further object is solved according to a further aspect of the invention by a filter system for filtering a fluid with a filter housing, which comprises at least one inlet for inflow of the fluid flow and at least one outlet for outflow of the purified fluid flow, and with a filter element for filtering the fluid, exchangeably arranged in the filter housing between a raw side and a clean side, with at least one filter bellows with a zigzag-shaped folded filter medium, with a raw side inlet surface and a clean side outlet surface, which filter bellows is arranged in a reinforcement frame arranged at the clean side, with at least one seal, which is arranged circumferentially at least partially continuously at least in sections at an outer circumferential side of the filter medium at the inlet surface or at the outlet surface of the filter bellows, in particular is connected by foaming or molding to the reinforcement frame, wherein at an inflow side and/or at an outflow side of folds of the filter bellows a plurality of elongate adhesive sections are arranged along an unwinding of the folds of the filter medium in at least two adhesive tracks, wherein adhesive tracks at the inflow side and adhesive tracks at the outflow side are arranged offset relative to each other in a transverse direction, wherein adhesive tracks at least in sections at least at the outflow side are configured so as to relieve tension for compensation of a length change of the adhesive tracks in relation to the filter medium and/or the seal.

Beneficial embodiments and advantages of the invention result from the additional claims, the description, and the drawing.

According to an aspect of the invention, a filter element for filtering a fluid, in particular air, is proposed, with at least one filter bellows with a zigzag-shaped folded filter medium, with a raw side inlet surface and a clean side outlet surface, wherein the filter bellows is arranged in a reinforcement frame, with at least one seal, which is arranged circumferentially at least partially continuously at least in sections at an outer circumferential side of the filter medium at the inlet surface and/or outlet surface of the filter bellows, in particular is connected by foaming or molding to the reinforcement frame. At an inflow side and/or at an outflow side of folds of the filter bellows, a plurality of elongate adhesive sections are arranged along an unwinding of the folds of the filter medium in at least two adhesive tracks. In this context, adhesive tracks at the inflow side and adhesive tracks at the outflow side are arranged offset relative each other in a transverse direction, wherein adhesive tracks at least in sections at least at the outflow side are configured so as to relieve tension for compensation of a length change of the adhesive tracks in relation to the filter medium and/or the seal.

The filter bellows can be folded to folds in a zigzag shape, for example, with parallel fold tips following sequentially in a length extension of the filter bellows and extending respectively between oppositely positioned end face edges of the filter bellows. The part of the fold which is positioned at the rear side of the fold tip is referred to as fold base.

In case of a flat filter, the flow direction is, for example, perpendicular to the inlet surface and the outlet surface which are provided at oppositely positioned flat sides of the filter bellows in case of a flat filter. Preferably, the outlet surface and the inlet surface of a filter with erect folds are the surfaces in which respectively the fold tips of folds of the filter medium are positioned.

The side of a fold of the filter medium which is facing the flowing fluid is referred to as inflow side of the fold, the side of the fold which is facing away from the flowing fluid is referred to as outflow side of the fold.

In this context, the filter bellows can be molded around circumferentially by a continuous reinforcement frame. Such a filter bellows is advantageously to be used as an air filter, for example, of an internal combustion engine, and provides an inexpensive and efficient solution of an air filter. Due to the molded-on frame, the filter bellows can be easily mounted and can also be exchanged, as needed.

The seal can be preferably a polyurethane (PUR) seal which can be produced in the region of the reinforcement frame by foaming or molding onto the filter bellows.

Advantageously, the filter element can be a so-called flat filter element. In case of a flat filter element in the meaning of the invention, the filter element is not closed to a hollow body.

The filter element according to the invention is not of an annular configuration. The flow-through sides are positioned axially opposite each other in relation to an element axis. In contrast thereto, in a hollow filter element, in particular a so-called round filter element, the filter medium is circumferentially closed and surrounds an interior. The filter element according to the invention can be planar or curved. In this context, an inlet surface and/or an outlet surface of the filter bellows for the fluid can be planar, bent or stepped. The filter element can also be box-shaped. The filter bellows can have approximately the shape of a polyhedron. Advantageously, the filter bellows can be of a cubic shape, cuboid shape, pyramid shape, prism shape, wedge shape or the like. In this context, it is not required that all sides, in particular circumferential sides, of the filter bellows are planar. At least one side of the filter bellows can also be at least partially curved, in particular parabolically curved, and/or stepped. Oppositely positioned sides can extend parallel. Alternatively or additionally, they can also extend at a slant or non-parallel to each other in a different way. Advantageously, the inlet surface and/or the outlet surface can extend respectively at least in sections perpendicularly or at a slant to the element axis.

Advantageously, the inlet surface and the outlet surface at least in sections can extend at a slant to each other and/or at least in sections parallel to each other. Advantageously, at least one filter bellows can comprise a filter medium which is of a zigzag shape and/or corrugated shape. In this manner, the surface of the filter medium which is to be flowed through by the fluid can be enlarged in relation to the spatial extension of the filter bellows.

Advantageously, fold tips of the filter medium can extend parallel at the oppositely positioned flow-through sides, in particular at an inlet surface and/or an outlet surface.

Advantageously, at least one filter bellows can comprise relatively deep folds and/or variable fold heights. The extension of a fold of the folded filter medium between an inflow side fold tip and a neighboring outflow side fold tip is referred to as fold height. In case of deep folds, the fold height, i.e., the height of the filter bellows in the region of the corresponding fold, is larger than a width and/or a length of the filter bellows perpendicular or transverse to the fold height.

The filter medium can comprise filter paper, filter nonwoven, meltblown, fabric and/or other types of filter material suitable for filtering fluid, in particular air. Advantageously, the filter medium can be flexible, in particular foldable or bendable.

According to the prior art, adhesive sections arranged usually at the end face are arranged as continuous adhesive tracks extending across the inlet surface or outlet surface on the fold tips of the folds of the filter medium.

According to the invention, adhesive tracks at an inflow side of the filter medium can be applied in relation to adhesive tracks at an outflow side of the filter medium so as to be displaced, for example, by half a distance of the adhesive tracks in transverse direction of the filter bellows. In this way, an adhesive track is arranged alternatingly at the inflow side and at the outflow side on the filter medium. In this way, the total quantity of applied glue is the same compared to a conventional application of adhesive tracks which are usually positioned opposite each other. The distance of adhesive tracks in transverse direction can however be cut in half in this way, which has a positive effect in respect to the stability of the filter bellows.

In addition, the adhesive tracks can comprise tension-relieving measures for compensation of a length change of the adhesive tracks in operation so that the adhesive track cannot tear and possibly damage the filter bellows upon shrinkage of the adhesive tracks due to environmental effects such as temperature changes. This is particularly important at the side of the filter bellows with the rigid plastic frame at which the seal is arranged because the filter bellows is fixedly connected to the frame and might detach from the frame upon shrinkage of the adhesive track.

Due to the tension-relieving measures, it can be advantageously avoided that the adhesive tracks will have adhesive openings due to shrinkage of the adhesive over time, which then can lead to leaks for the fluid to be purified between the seal and the filter medium. The advantage of tension-relieving measures resides in that relatively wide detachment effects as a result of the shrinkage of the adhesive will no longer occur in the critical joining region of the filter bellows at the seal. The shrinkage of the adhesive can still occur so that no corresponding tensions are caused in these regions.

According to an advantageous embodiment of the filter element, adhesive sections and adhesive gaps can be arranged alternatingly in a tension-relieving manner at each adhesive track for compensation of a length change of the adhesive tracks in relation to the filter medium and/or the seal.

In this way, the adhesive tracks can comprise, as a tension-relieving measure for compensation of a length change of the adhesive tracks in operation, a sequence of shorter adhesive sections and adhesive gaps so that the adhesive track cannot tear and possibly damage the filter bellows upon shrinkage of the adhesive tracks due to environmental effects such as temperature changes. This is in particular important at the side of the filter bellows with the rigid plastic frame at which the seal is arranged because the filter bellows is fixedly connected to the frame and might detach from the frame upon shrinkage of the adhesive track.

As a further advantage, transverse air flows can be made possible in the filter bellows which reduces the clogging risk due to deposited dirt in the filter bellows.

According to an advantageous embodiment of the filter element, adhesive sections at the inflow side can be arranged so as to alternate, in particular overlap, with adhesive gaps at the outflow side along the unwinding of the folds. In this way, an advantageous flexibility of the filter bellows can be maintained despite stabilization by the adhesive tracks.

According to an advantageous embodiment of the filter element, adhesive sections which extend across a fold tip can be arranged at the inflow side or at the outflow side, respectively. Alternatively or additionally, adhesive gaps which extend across the fold tip can be arranged at the outflow side or at the inflow side, respectively. In this way, the fold tips can be particularly stabilized and protected against possible damages by the adhesive sections on the fold tips and still maintain their flexibility due to the adhesive gaps at the rear side of the fold tips, i.e., the fold base.

According to an advantageous embodiment of the filter element, at least one rim region can be exempt from adhesive sections in the fold bases in case of folds at the inflow side. In this way, for example, the first and the last five or/up to ten folds of the filter bellows can be embodied without adhesive tracks in the rim region or in the fold base. In this way, a higher flexibility of the filter bellows against possible vibration loads can be advantageously achieved.

According to an advantageous embodiment of the filter element, folds at the outflow side can comprise at least one and preferably a plurality of adhesive gaps at the fold tips which are visible from the exterior at the outflow side, wherein at least one and preferably a plurality of adhesive gaps are arranged at fold tips, which are visible from the exterior at the outflow side, at the folds in which also fold bases at the inflow side are exempt from adhesive sections.

According to an advantageous embodiment of the filter element, adhesive sections which extend into a fold base can be arranged at the inflow side, respectively. Alternatively or additionally, adhesive gaps which extend into the fold base can be arranged at the outflow side. In this way, the filter bellows can be stabilized beneficially at the outlet surface while sufficient flexibility against possible vibration loads is maintained at the inlet surface.

According to an advantageous embodiment of the filter element, fold tips at the outflow side can comprise additional adhesive gaps which are arranged in such a distribution that additional adhesive gaps of neighboring adhesive tracks are arranged at different fold tips in relation to a transverse direction relative to the folds. In particular, the additional adhesive gaps can extend at least across one fold.

Additional, in particular longer, adhesive gaps can contribute as a further tension-relieving measure to compensation of a length change of the adhesive tracks in operation so that the adhesive tracks cannot tear and possibly damage the filter bellows upon shrinkage of the adhesive tracks due to environmental effects such as temperature changes. This is particularly important at the side of the filter bellows with the rigid plastic frame at which the seal is arranged because the filter bellows is fixedly connected to the frame and might detach from the frame upon shrinkage of the adhesive track.

According to an advantageous embodiment of the filter element, the adhesive sections and the adhesive gaps of neighboring adhesive tracks can be arranged in relation to a transverse direction relative to the folds at a same level in relation to the unwinding of the folds, respectively. In this way, an advantageous stability of the filter bellows can be achieved. In addition, in this way the manufacture of the filter element can be additionally simplified when identical patterns and lengths of adhesive sections and adhesive gaps are used.

According to an advantageous embodiment of the filter element, the adhesive sections and the adhesive gaps can be embodied with the same length. In this manner, a good compromise can be achieved between stability of the filter bellows and avoidance of potential risks due to shrinkage of the adhesive tracks with thereby caused detachment of the filter bellows from the frame.

According to an advantageous embodiment of the filter element, the adhesive tracks can be arranged parallel and equidistantly to each other. Alternatively or additionally, the adhesive gaps can be arranged uniformly distributed across the inflow side and/or across the outflow side. In this way, a stabilization of the filter bellows as uniformly as possible can be achieved.

According to an advantageous embodiment of the filter element, the adhesive tracks can extend perpendicularly to the fold tips. In this way, a stabilization of the filter bellows as uniformly as possible can be achieved.

According to an aspect of the invention, a filter system for filtering a fluid is proposed with a filter housing which comprises at least one inlet for inflow of the fluid flow and at least one outlet for outflow of the purified fluid flow, and with a filter element for filtering the fluid exchangeably arranged in the filter housing between a raw side and a clean side, with at least one filter bellows with a zigzag-shaped folded filter medium, with a raw side inlet surface and a clean side outlet surface, which filter bellows is arranged in a reinforcement frame arranged at the clean side, with at least one seal, which circumferentially at least partially continuously at least in sections is arranged at an outer circumferential side of the filter medium at the inlet surface or at the outlet surface of the filter bellows, in particular is connected by foaming or molding to the reinforcement frame. At an inflow side and/or at an outflow side of folds of the filter bellows, a plurality of elongate adhesive sections are arranged in at least two adhesive tracks along an unwinding of the folds of the filter medium. In this context, adhesive tracks at the inflow side and adhesive tracks at the outflow side are arranged offset relative to each other in a transverse direction, wherein adhesive tracks at least in sections at least at the outflow side are configured so as to relieve tension for compensation of a length change of the adhesive tracks in relation to the filter medium and/or the seal.

The filter bellows can be folded to folds, for example, in a zigzag shape, with parallel fold tips sequentially following each other in a length extension of the filter bellows and extending between oppositely positioned end face edges of the filter bellows, respectively. In this context, the filter bellows can be molded around circumferentially with a continuous reinforcement frame. Such a filter bellows is advantageously to be used as an air filter, for example, of an internal combustion engine, and constitutes an inexpensive and efficient solution of an air filter. Due to the molded-on frame, the filter bellows can be easily mounted and also exchanged, as needed.

The seal can be preferably a polyurethane (PUR) seal which can be produced by foaming or molding onto the filter bellows in the region of the reinforcement frame.

The flow direction in case of a flat filter is, for example, perpendicular to the inlet surface and outlet surface which in case of a flat filter are provided at oppositely positioned flat sides of the filter bellows. Preferably, the outlet surface and the inlet surface in case of a filter with erect folds are the surfaces in which the fold tips of folds of the filter medium are positioned, respectively.

According to the prior art, adhesive sections arranged usually at the end face are arranged as continuous adhesive tracks extending across the inlet surface or outlet surface on the fold tips of the folds of the filter medium.

Advantageously, adhesive tracks at an inflow side of the filter medium can be applied, for example, displaced by half a distance of the adhesive tracks in transverse direction of the filter bellows in relation to adhesive tracks on an outflow side of the filter medium. In this way, an adhesive track is alternatingly applied at the inflow side and at the outflow side on the filter medium. In this way, the total quantity of applied glue remains the same in comparison to a conventional application of adhesive tracks which are usually applied so as to be positioned opposite each other. The distance of the adhesive tracks in transverse direction can however be cut in half in this way, which has a positive effect on the stability of the filter bellows.

In addition, the adhesive tracks can comprise tension-relieving measures for compensation of a length change of the adhesive tracks in operation so that upon shrinkage of the adhesive tracks due to environmental effects such as temperature changes the adhesive track cannot tear and possibly damage the filter bellows. This is in particular important on the side of the filter bellows with the rigid plastic frame at which the seal is arranged because the filter bellows is fixedly connected to the frame and might detach from the frame upon shrinkage of the adhesive track.

Due to the tension-relieving measures, it can be advantageously avoided that the adhesive tracks will have adhesive openings due to shrinkage of the adhesive over time, which then can lead to leaks for the fluid to be purified between the seal and the filter medium. The advantage of the tension-relieving measures resides in that relatively wide detachment effects as a result of the shrinkage of the adhesive will no longer occur in the critical joining region of the filter bellows at the seal. The shrinkage of the adhesive can still occur so that no corresponding tensions occur in these regions.

According to an advantageous embodiment of the filter system, a cyclone preseparator can be provided in the filter housing fluidically upstream in front of the filter element. As an alternative or in addition, a safety element can be provided fluidically downstream behind the filter element.

Advantageously, the filter can be embodied as a multi-stage filter, in particular two-stage compact air filter. Advantageously, at least one filter element can be arranged fluidically downstream of at least one particle separation device, in particular a cyclone preseparator. The at least one particle separation device can be part of the filter or can be connected upstream thereof externally, in particular as a preseparator. An external preseparator can be arranged outside of a motor compartment. Advantageously, at least one inlet opening, at least one outlet opening and, as needed, a particle separation device can be arranged substantially linearly. In this manner, the fluid can flow accordingly through the filter in particular substantially along a housing axis of the filter housing.

According to an advantageous embodiment of the filter system, by means of the seal of the filter element, with the filter element installed as intended, the raw side can be separated from the clean side. In this manner, a reliable cleaning of the inflowing fluid can be ensured while providing a long service life of the filter element.

According to an advantageous embodiment of the filter system, the filter element can be configured as an insertion filter element that is inserted or insertable into the filter housing transversely to the main flow axis of the fluid. In this way, an expedient exchange of the filter element when loaded is possible. Also, the duration of a service stay with standstill of the internal combustion engine or of the vehicle can be reduced.

The described filter system can be used advantageously as an air filter, in particular as an air filter of an internal combustion engine or as an interior air filter, in particular of a motor vehicle.

The invention can be used in motor vehicles, construction/agricultural machines, compressors, industrial motors or other devices with internal combustion engines. Vehicles in the meaning of the invention can be land vehicles, watercraft and/or aircraft.

Advantageously, the motor vehicle can be a passenger car, a truck, motorcycle, a motor coach, a tractor, an agricultural vehicle and/or a construction vehicle or the like.

The invention can advantageously be part of an intake air manifold of an internal combustion engine. The filter can serve for cleaning combustion air which is supplied to the internal combustion engine. The invention is however not limited to an air filter of an intake air manifold of an internal combustion engine of a motor vehicle. Instead, it can also be used in other types of air systems of motor vehicles or other machines, in particular agricultural machines or construction machines. The air filter can also be used outside of automotive technology, in particular in industrial motors.

Furthermore, the features and advantages which have been disclosed in connection with the filter element according to the invention, the element frame according to the invention, the filter bellows according to the invention, the filter housing according to the invention, and the filter according to the invention and their respective advantageous embodiments apply correspondingly among each other and vice versa. The individual features and advantages can, of course, be combined among each other, wherein further advantageous effects may result which surpass the sum of the individual effects.

### BRIEF DESCRIPTION OF DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows an isometric illustration of a filter system with mounted filter element according to an embodiment of the invention.

FIG. 2 shows an isometric illustration of the filter system according to FIG. 1 with a view of an inlet.

FIG. 3 shows a longitudinal section through the filter system according to FIG. 1.

FIG. 4 shows an isometric illustration of a filter element according to an embodiment of the invention with a view of an outlet surface.

FIG. 5 shows an isometric illustration of the filter element according to FIG. 4 with a view of an inlet surface.

FIG. 6 shows a further isometric illustration of the filter element according to FIG. 4 with a view of the outlet surface.

FIG. 7 shows a further isometric illustration of the filter element according to FIG. 4 with a view of the inlet surface.

FIG. 8 shows a plan view of the outlet surface of the filter element according to FIG. 4 with indicated section planes A-A, B-B, C-C, D-D, E-E, F-F.

FIG. 9 shows a longitudinal section of the filter element in the section plane A-A according to FIG. 8 with adhesive tracks arranged on an inflow side of the folds.

FIG. 10 shows a longitudinal section of the filter element in the section plane B-B according to FIG. 8 with adhesive tracks arranged on an outflow side of the folds.

FIG. 11 shows a cross section of the filter element in the section plane D-D according to FIG. 8 with adhesive tracks arranged on the outflow side of the folds.

FIG. 12 shows a cross section of the filter element in the section plane C-C according to FIG. 8 with adhesive tracks arranged on the outflow side of the folds.

FIG. 13 shows a cross section of the filter element in the section plane F-F according to FIG. 8 with adhesive tracks arranged on the inflow side of the folds.

FIG. 14 shows a cross section of the filter element in the section plane E-E according to FIG. 8 with adhesive tracks arranged on the inflow side of the folds.

FIG. 15 shows superimposed cross sections of the filter element in the section planes D-D and F-F in accordance with FIG. 8 with adhesive tracks arranged on the outflow side and on the inflow side.

### DETAILED DESCRIPTION

In the Figures, same or same-type components are identified with same reference characters. The Figures show only examples and are not to be understood as limiting.

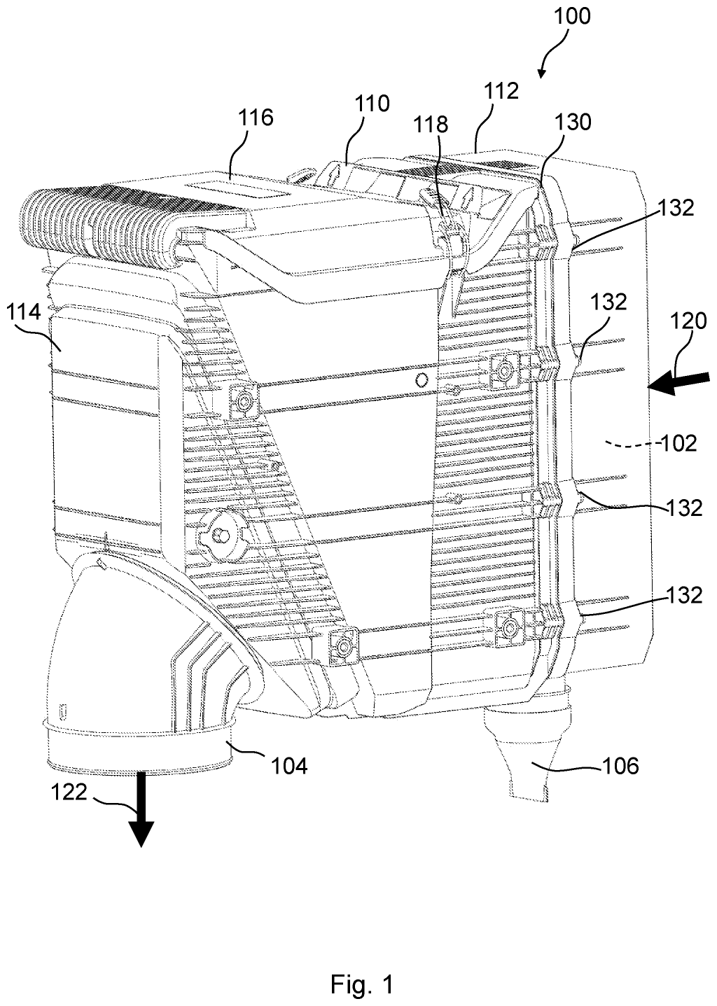

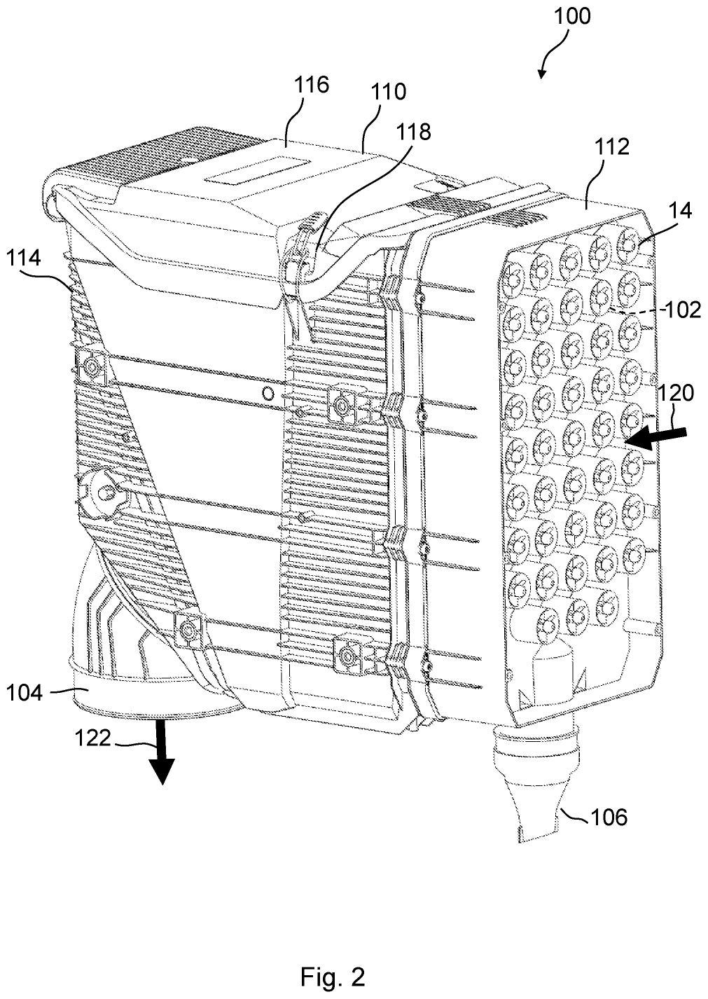

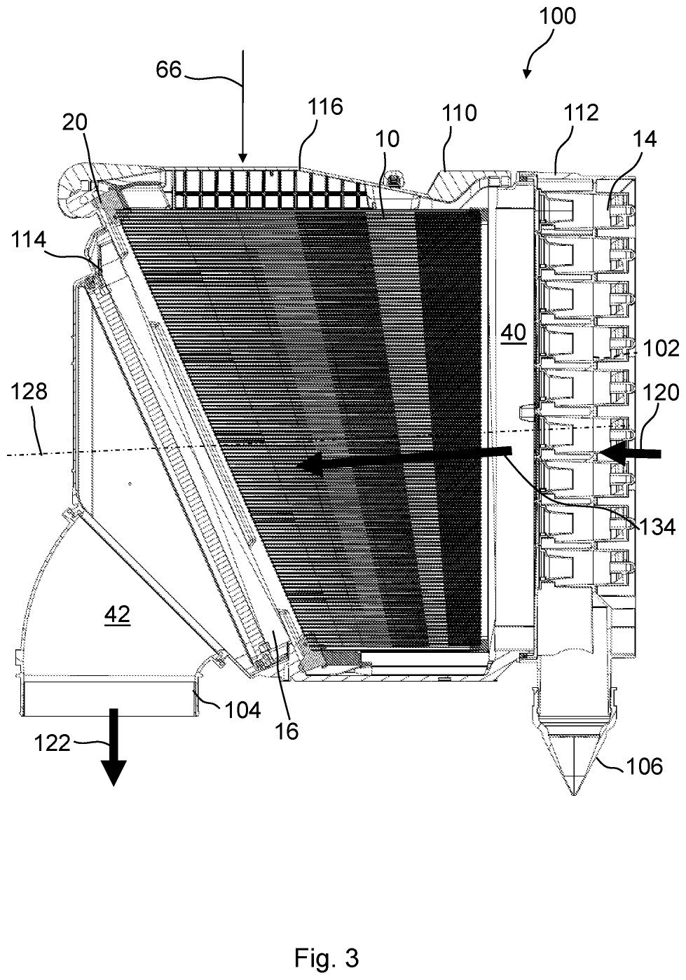

FIG. 1 shows an isometric illustration of a filter system 100 for filtering a fluid with mounted filter element 10 according to an embodiment of the invention while in FIG. 2 an isometric illustration of the filter system according to FIG. 1 with a view of an inlet 102 is illustrated. For a better understanding, FIG. 3 shows a longitudinally sectioned illustration of the filter system 100.

The filter system 100 comprises a filter housing 110 which comprises at least one inlet 102 (not visible) for inflow of the fluid flow 120 and at least one outlet 104 for outflow of the purified fluid flow 122. The filter housing 110 comprises a housing bottom part 114 and a housing top part 112 which are joined along a flange 130 by means of screw connections 132. A filter element 10 for filtering the fluid is exchangeably arranged in the filter housing 110 between a raw side 40 and a clean side 42. The filter element 10 can be inserted into and removed from the filter housing 110 via the housing cover 116 which can be tightly closed by means of clamping closures 118 with the filter housing 110. The inflow direction of the fluid to be purified as well as the outflow direction are indicated by arrows 120, 122.

In longitudinal section of the filter system 100 in FIG. 3, the filter element 10, also sectioned, can be seen which is inserted in the filter housing 110. Further, a cyclone preseparator 14 can be seen which is embodied as a multi-cyclone where coarse dirt particles can be filtered out of the fluid flow. The separated dirt particles can be discharged through the dirt outlet 106 from the filter housing. The flow direction 134 of the filter element 10 is indicated with an arrow. Downstream, before the purified fluid can exit the filter housing 110 through the outlet 104, the fluid flows also through a safety element 16 which can be embodied, for example, as a flat bellows in order to protect, also for exchanging the filter element 10, the clean side 42 from a possible contamination by inflow of not yet purified fluid or other dirt particles. The safety element 16 covers the outlet 104 completely.

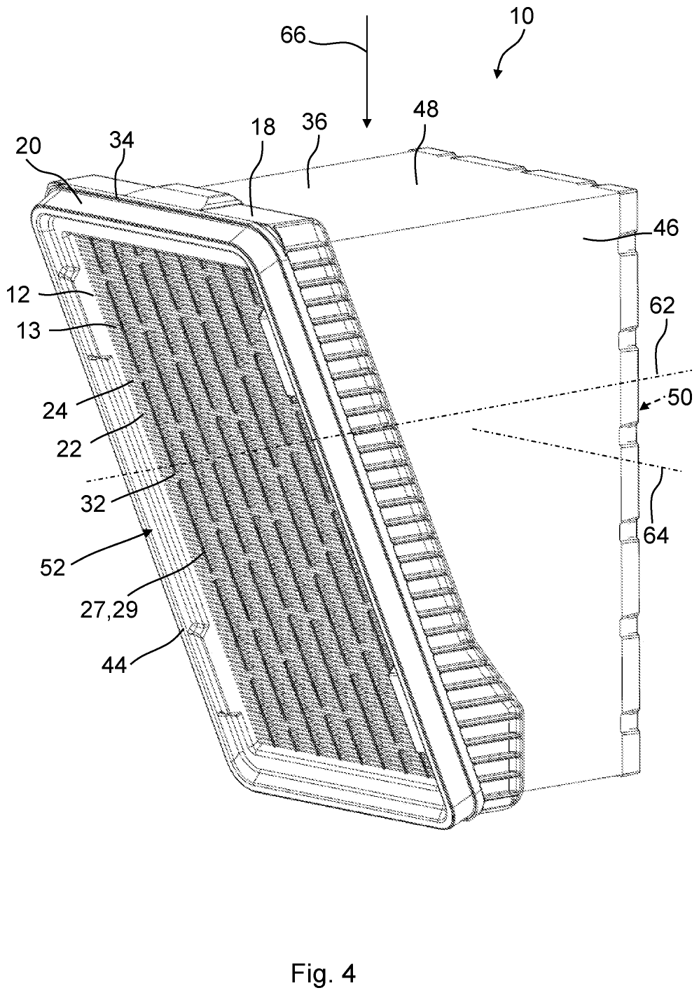

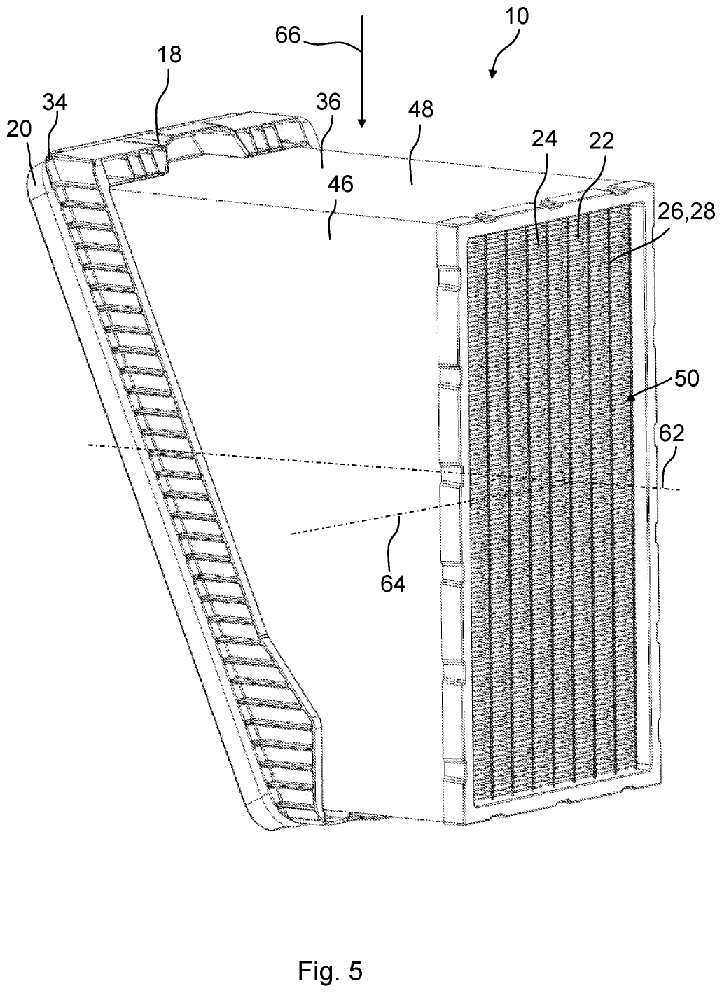

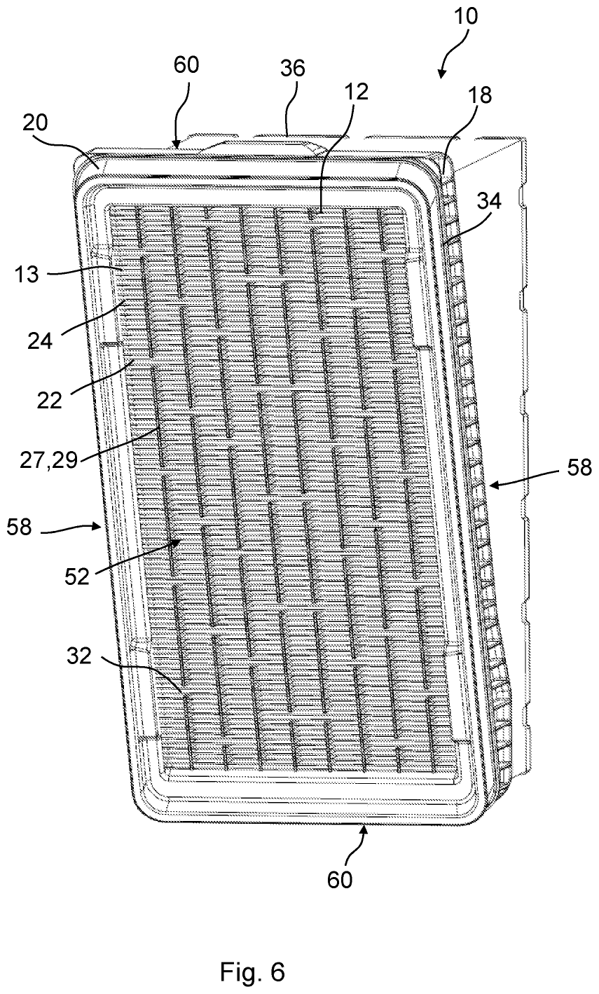

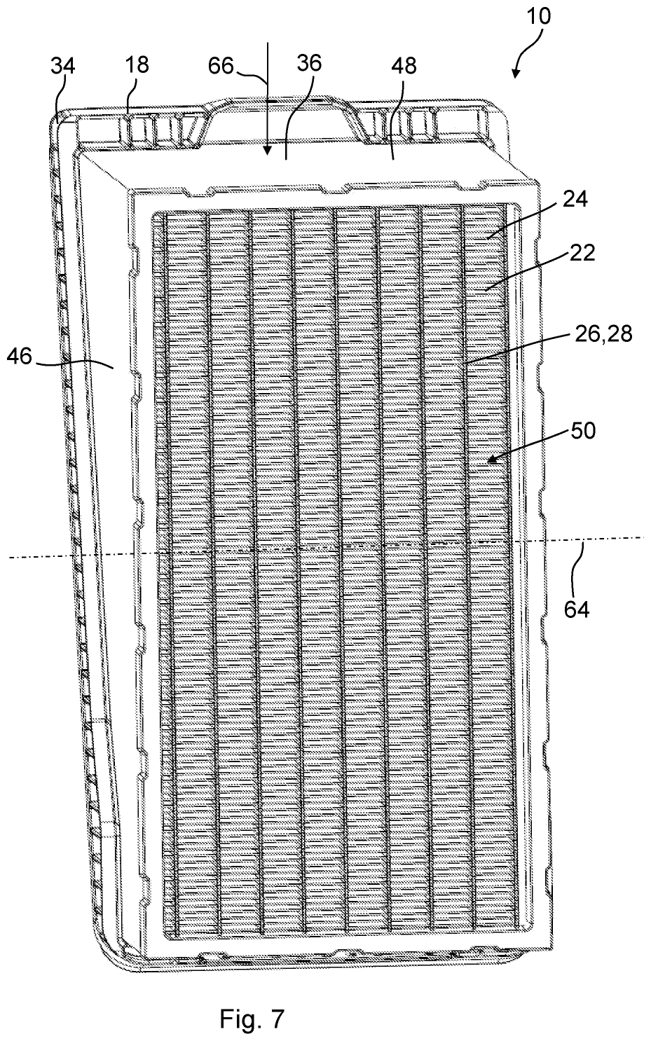

The filter element 10 which is inserted in the filter system 100, as illustrated in FIGS. 1, 2 and 3, can be seen in FIG. 4 in an isometric illustration with a view of an outlet surface 52 as well as in FIG. 5 with a view of an inlet surface 50. FIG. 6 shows a further isometric illustration of the filter element 10 according to FIG. 4 with a view of the outlet surface 52 and FIG. 7 with a view of the inlet surface 50.

The filter element 10 comprises a filter bellows 12 which is inserted into an element frame 36.

The filter element 10 is configured as an insertion filter element which is inserted or insertable transverse to the main flow axis 128 (see FIG. 3) of the fluid into the filter housing 110.

The filter bellows 12 comprises a zigzag-shaped folded filter medium 13. The filter bellows 12 is rectangular, viewed in a direction of a main axis 62. Viewed in direction of a transverse direction 64, the filter bellows 12 has approximately the shape of a rectangular trapezoid. A raw side inlet surface 50 of the filter bellows 12 extends parallel to a flow center plane, i.e., perpendicularly to the main axis 62. A clean side outlet surface 52 extends parallel to the transverse direction 64 and at a slant to the flow center plane, i.e., at a slant to the inlet surface 50.

The filter bellows 12 tapers, viewed in installation direction 66, toward its transverse front side. The fold tips 24 of the filter medium 13 at the inlet surface 50 and at the outlet surface 52 extend parallel to the transverse direction 64, respectively. The fold tips 24 define the inlet surface 50 and the outlet surface 52, respectively. The heights of the folds 22 of the folded filter medium 13 in the direction of the main axis 62 become smaller from the transverse side of the filter bellows 12 to the rear in relation to the installation direction 66 toward its transverse front side. The filter bellows 12 thus has variable fold heights.

The outlet surface 52 is surrounded by the seal 20. By means of the seal 20 of the filter element 10, the raw side 40 is separated from the clean side 42 of the filter element 10, with the filter element 10 installed as intended.

The seal 20 can be, for example, of polyurethane (PUR). It is elastic. The seal 20 is foamed onto the end face of the filter medium 13. In relation to the main axis 62, the seal 20 projects past the filter medium 13 radially outwardly and in axial direction. An end face seal lip of the seal 20 at the outflow side forms a seal surface 44 which is circumferentially continuous in relation to the main axis 62. The seal surface 44 is positioned at a housing-side seal surface in the installed state.

A reinforcement frame 18 of plastic material is embedded in the seal track of the seal 20 at the rear side of the seal 20 which is axially facing away from the seal surface 44 in relation to the main axis 62. The reinforcement frame 18 extends parallel to the seal plane and parallel to the seal surface 44. The reinforcement frame 18 is circumferentially continuous in relation to the main axis 62. The seal rear side of the seal 20, which is axially facing away from the seal surface 44 in relation to the main axis 62, extends in a plane parallel to the plane of the seal surface 44. With installed filter element 10, the respective planes of the seal surface 44 and of the seal rear side extend parallel to the seal plane of the housing-side seal surface.

The element frame 36 comprises the seal support device 34 at the outlet surface 52. The seal support device 34 is arranged at an outflow side rim of the element frame 36. The seal support device 34 extends circumferentially continuously in relation to the main axis 62 at the outer side of the filter element 10. The seal support surface 34 is connected as one piece with the longitudinal walls 46 and the transverse walls 48 of the element frame 36.

At an inflow side 70 and at an outflow side 72 of folds 22 of the filter bellows 12, a plurality of elongate adhesive sections 28, 29 are arranged in at least two adhesive tracks 26, 27 along an unwinding of folds 22 of the filter medium 13. The adhesive tracks 26 at the inflow side 70 and the adhesive tracks 27 at the outflow side 72 are arranged offset relative to each other in the transverse direction 64.

The adhesive tracks 26, 27 extend perpendicularly to the fold tips 24 of the folds 22 of the filter bellows 12.

The adhesive tracks 26, 27 are configured to relieve tension at least in sections at least at the outflow side 72 for compensation of a length change of the adhesive tracks 26 in relation to the filter medium 13 and/or the seal 20.

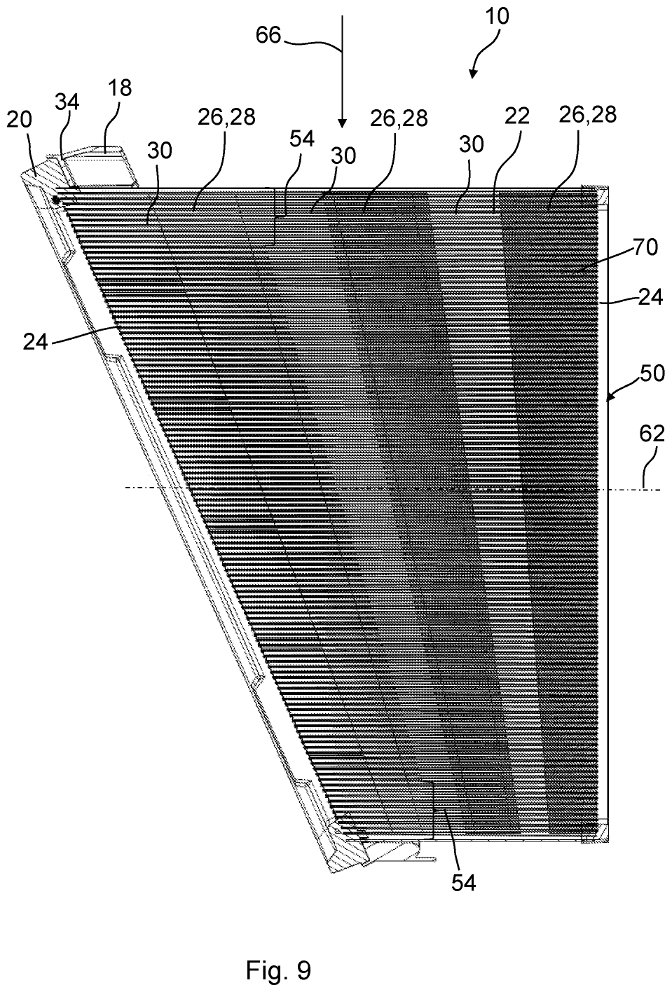

For compensation of a possible length change of the adhesive tracks 26, 27 in relation to the filter medium 13 and/or the seal 20, adhesive sections 28, 29 and adhesive gaps 30, 31 can be arranged alternatingly on each adhesive track 26, 27 to provide tension relief. Details thereof can be seen in FIGS. 9 to 15.

In the embodiment of the filter element 10 illustrated in FIGS. 4 to 7, the inlet side adhesive tracks 26 are applied continuously without adhesive gaps while fold tips 24 at the outflow side 72 have additional adhesive gaps 32. The additional adhesive gaps 32 are arranged in this context such that additional adhesive gaps 32 of neighboring adhesive tracks 27 are arranged in relation to a transverse direction 64 relative to the folds 22 on different fold tips 24. In particular, the additional adhesive gaps 32 can extend across one or a plurality of folds 22.

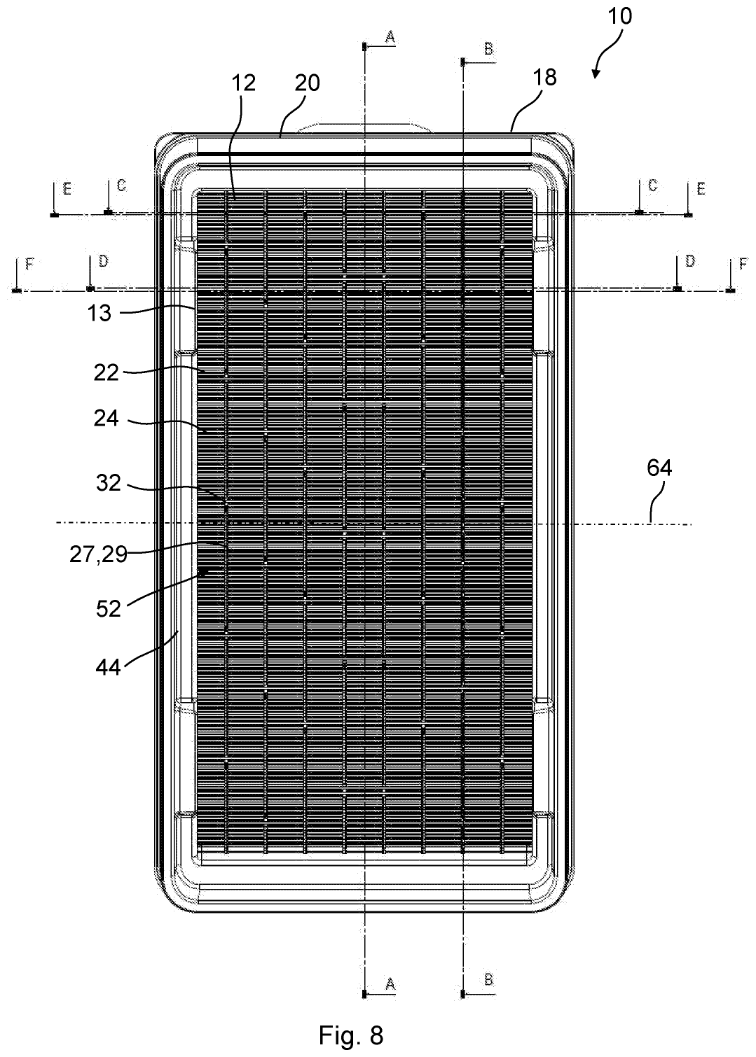

FIG. 8 shows a plan view of the outlet surface 52 of the filter element 10 according to FIG. 4 with indicated section planes A-A, B-B, C-C, D-D, E-E, F-F. The adhesive tracks 27 extend perpendicularly to the fold tips 24 and are equidistantly arranged in the transverse direction 64. The adhesive tracks 27 comprise additional adhesive gaps 32.

FIG. 9 shows a longitudinal section of the filter element 10 in the section plane A-A according to FIG. 8 with adhesive tracks 26 arranged at an inflow side 70 of the folds 22. In the longitudinal section of the filter element 10, the adhesive sections 28 and adhesive gaps 30 of the adhesive tracks 26 can be seen in section as stripes which extend across the entire extension of the filter bellows 12 in installation direction 66.

At the inflow side 70, folds 22 of the rim regions 54 are exempt from adhesive sections 28, 29 at the fold tips 24 in order to maintain a higher flexibility of the filter bellows 12.

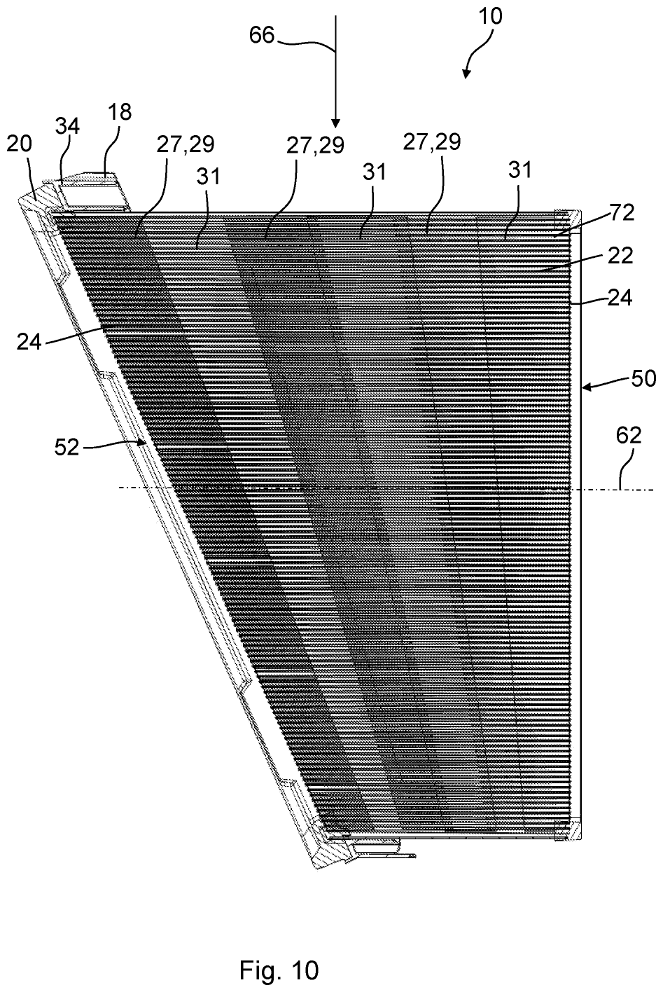

FIG. 10 shows a longitudinal section of the filter element 10 in the section plane B-B according to FIG. 8 with corresponding adhesive tracks 27 at an outflow side 72.

As can be seen when comparing the longitudinal sections in FIGS. 9 and 10, adhesive sections 28, 29 at the inflow side 70 and adhesive gaps 30, 31 at the outflow side 72 are arranged alternatingly along the unwinding of the folds 22. Optionally, the adhesive sections 28, 29 and the adhesive gaps 30, 31 of the respective oppositely positioned side 70, 72 can be arranged so as to slightly overlap.

At the inflow side 70 or the outflow side 72, adhesive sections 28, 29 are arranged, respectively, which extend across a fold tip 24. As an alternative or in addition, adhesive gaps 30, 31 which extend across a fold tip 24 can be arranged, respectively, at the outflow side 72 or the inflow side 70. When, for example, on one side 70, 72 the fold tips 24 comprise an adhesive section 28, 29, the corresponding fold base can comprise an adhesive gap 30, 31 and vice versa.

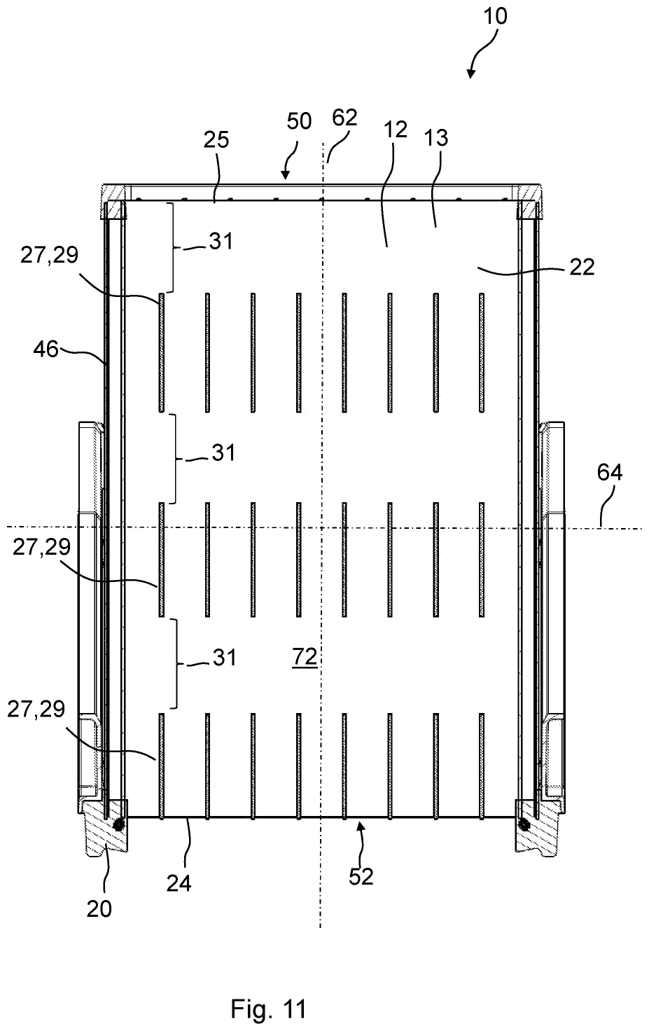

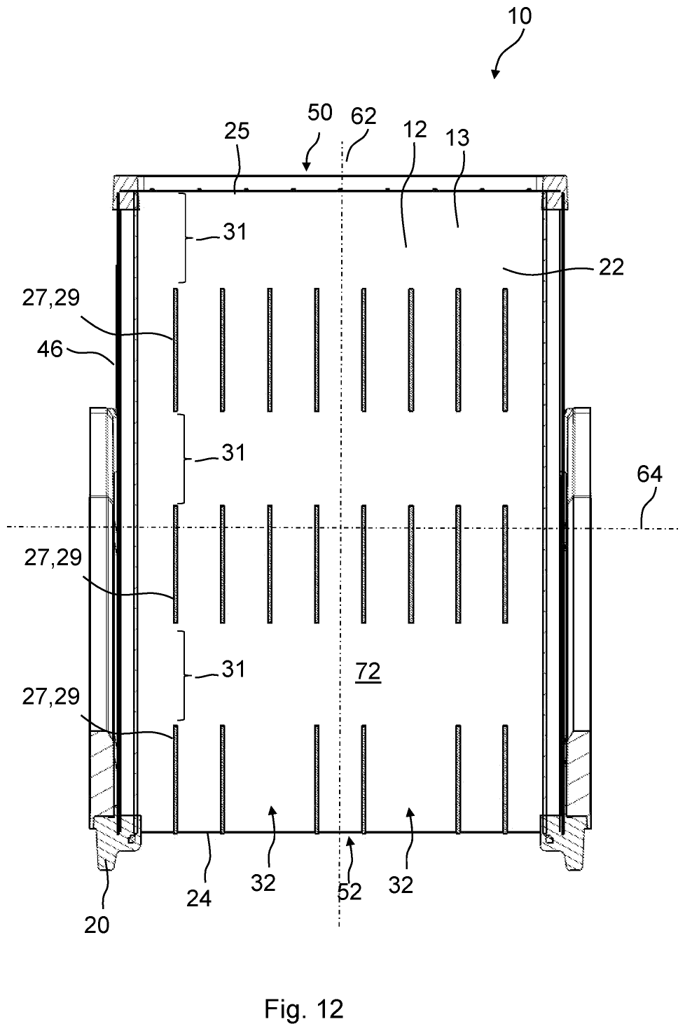

In FIG. 11, a cross section of the filter element 10 in the section plane D-D according to FIG. 8 is illustrated with adhesive tracks 27 arranged at the outflow side 72 while in FIG. 12 a cross section in the section plane C-C is illustrated. In cross section, the unwinding of the fold 22 can be seen in the image plane as outflow side 72 of the fold 22.

The adhesive tracks 27 have alternating adhesive sections 29 and adhesive gaps 31. The adhesive tracks 27 are arranged parallel and equidistantly to each other. As an alternative or in addition, the adhesive gaps 31 can be arranged, uniformly distributed, across the outflow side 72.

As can be seen in FIGS. 11 and 12, at the outflow side 72 adhesive gaps 31 are arranged at the fold base 25 of the folds which is positioned at the inlet surface 50 in the illustration.

The adhesive sections 29 and the adhesive gaps 31 of neighboring adhesive tracks 27 are arranged in relation to the transverse direction 64 relative to the folds 22 at the same level in relation to the unwinding of the folds 22, respectively.

The adhesive sections 28, 29 and the adhesive gaps 30, 31 can be embodied, for example, with the same length or at least approximately the same length as in the embodiment illustrated in FIGS. 11 and 12.

In the cross section in FIG. 12, two additional adhesive gaps 32 at the fold tip 24 of the outlet surface 52 can be seen where the corresponding adhesive sections 29 are missing.

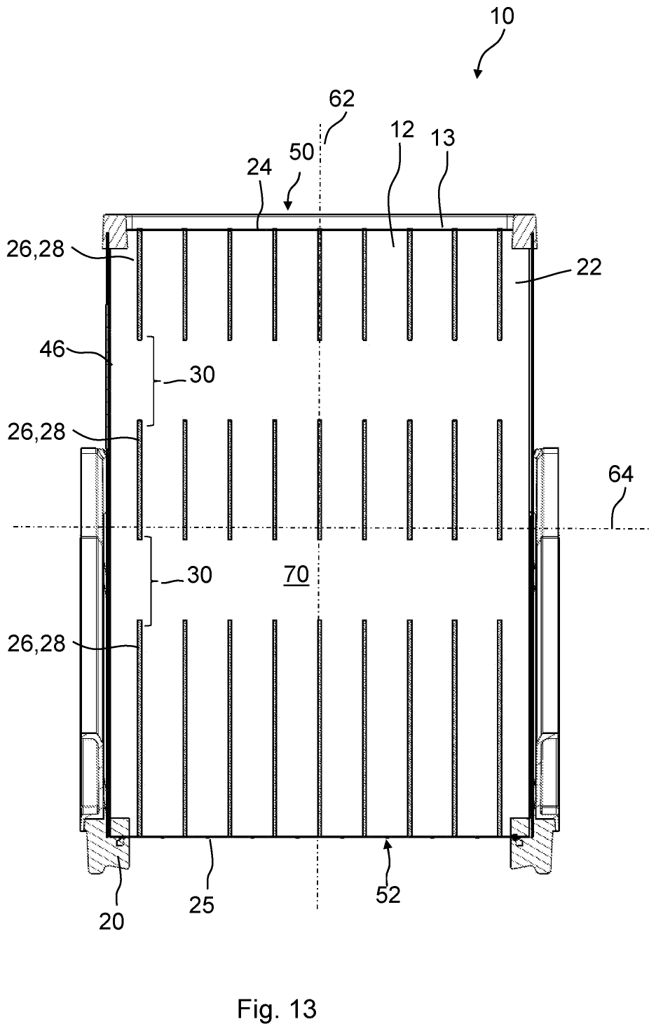

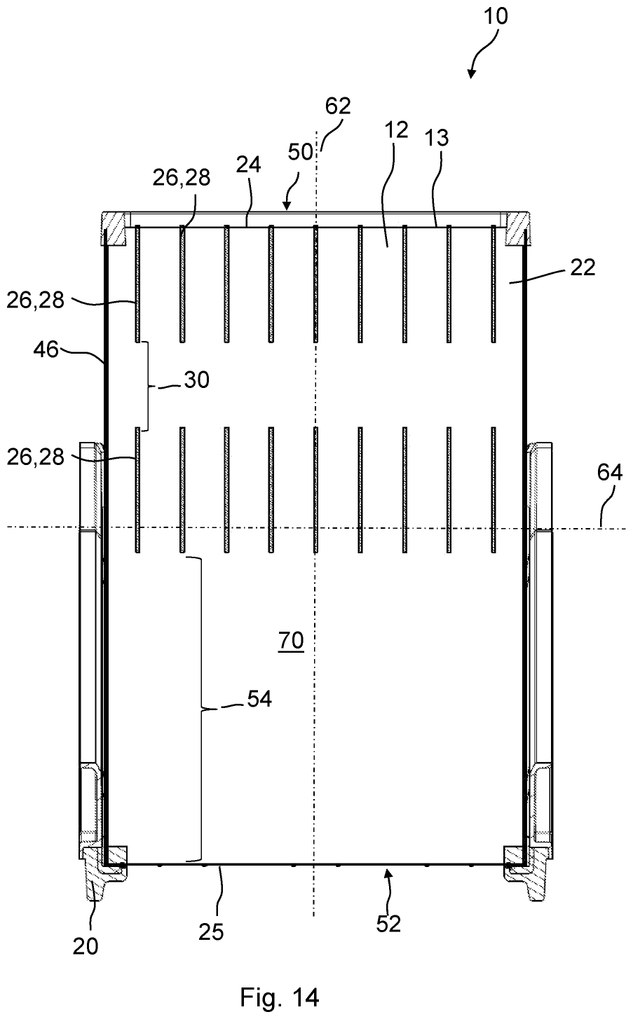

In FIG. 13, a cross section of the filter element 10 in the section plane F-F according to FIG. 8 with adhesive tracks 26 arranged at the inflow side 70 is illustrated while in FIG. 14 a cross section in the section plane E-E according to FIG. 8 is illustrated.

The adhesive tracks 26 are arranged offset in the transverse direction 64 in relation to the adhesive tracks 27 in the FIGS. 11 and 12 so as to alternate. Adhesive sections 28 and adhesive gaps 30 of the inflow side 70 and the adhesive sections 29 and adhesive gaps 31 of the outflow side 72 are alternatingly arranged.

As can be seen in FIGS. 13 and 14, adhesive sections 28, which extend in a fold base 25 positioned at the outlet surface 52 in the illustration, are arranged, respectively, at the inflow side 70, intended here are the inflow side inner walls of the inflow side fold pockets of the folds 22. For this purpose, the adhesive sections 28 in the fold base 25 are configured longer than the adhesive sections 28 on the remaining surface of the inflow side 70 of the fold 22. Preferably, in a rim region 54 lying in the fold base 25 of the first and/or last folds 22 or fold pockets of the inflow side 70 of the folds 22, no adhesive sections 28 are provided, i.e., at least at one end of the filter bellows 12, for example, in the fold bases 25 of the first or the last five up to/or ten folds, the rim region 54 or the fold bases 25 are exempt from adhesive sections 28. In this way, the folds, when under tensile load, can spread open transversely to the direction of the fold edges and reduce the tensile stress by deformation so that the risk of a tear is reduced. As in the illustrated filter element 10, it is advantageously provided that at the outflow side 72 of the first and/or last folds 22, at the fold tips 24 which are visible from the exterior at the outflow side, at least one and preferably a plurality of adhesive gaps are arranged. These adhesive gaps are preferably arranged at the folds 22 in which fold bases 25 are also exempt from adhesive sections at the inflow side. In this way, in a limited end region of the filter bellows 12 in the region of the first or last folds 22, a good deformability transverse to the direction of the fold edges can be achieved and a tear risk can be reduced.

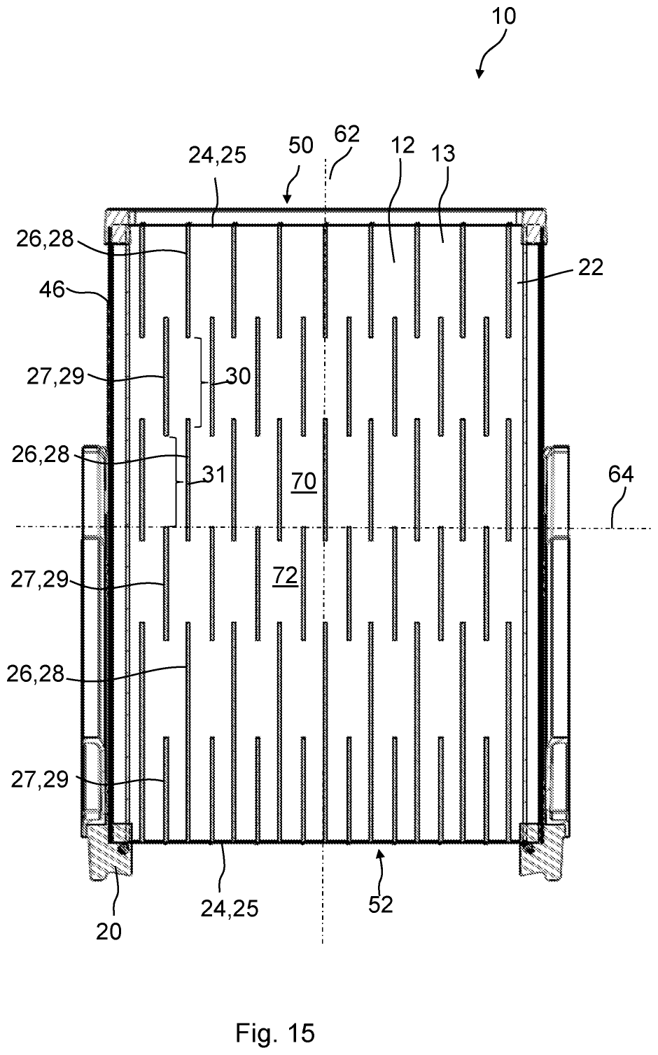

In FIG. 15, the cross sections in the section planes D-D and F-F according to FIG. 8 of the filter element 10 illustrated in FIGS. 11 and 13 are superimposed so that the offset arrangement of the two adhesive tracks 26, 27 at the inflow side 70 and at the outflow side 72 can be seen. Also, the alternating arrangement of the adhesive sections 28 of the inflow side 70 relative to the adhesive gaps 31 of the outflow side 72 as well as of the adhesive sections 29 of the outflow side 72 relative to the adhesive gaps 30 of the inflow side 70 can be clearly seen. The adhesive sections 28, 29 are formed with a minimal overlap, respectively.

### REFERENCE CHARACTERS

10 filter element
12 filter bellows
13 filter medium
14 cyclone preseparator
16 safety element
18 reinforcement frame
20 seal
22 fold
24 fold tip
25 fold base
26 adhesive track
27 adhesive track
28 adhesive section
29 adhesive section
30 adhesive gap
31 adhesive gap
32 additional adhesive gap
34 seal support device
36 element frame
40 raw side
42 clean side
44 seal surface
46 longitudinal wall
48 transverse wall
50 inlet surface
52 outlet surface
54 rim region
58 longitudinal side
60 transverse side
62 main axis
64 transverse direction
66 installation direction
70 inflow side
72 outflow side
100 filter system
102 inlet
104 outlet
106 dirt outlet
110 filter housing
112 housing top part
114 housing bottom part
116 housing cover
118 clamping closure
120 raw fluid flow
122 clean fluid flow
128 main flow axis
130 flange
132 screw connection
134 flow direction

What is claimed is:

1. A filter element for filtering a fluid, comprising:
a filter bellows comprising a zigzag-shaped folded filter medium with folds and further comprising a raw side inlet surface and a clean side outlet surface;
a reinforcement frame, wherein the filter bellows is arranged in the reinforcement frame;
at least one seal arranged circumferentially at least partially continuously at least in sections at an outer circumferential side of the filter medium at the raw side inlet surface or at the clean side outlet surface of the filter bellows;
elongate adhesive sections arranged along an unwinding of the folds of the filter medium in adhesive tracks at an inflow side of the folds or in adhesive tracks at an outflow side of the folds;
wherein the adhesive tracks at the inflow side and the adhesive tracks at the outflow side are arranged offset relative to each other in a transverse direction of the filter medium;
wherein at least the adhesive tracks at the outflow side are configured, at least in sections, to relieve tension for a compensation of a length change of the adhesive tracks at the outflow side in relation to the filter medium or the seal.

2. The filter element according to claim 1, wherein the adhesive tracks at the outflow side and the adhesive tracks at the inflow side each comprise first adhesive gaps, wherein the elongate adhesive sections and the first adhesive gaps of each one of the adhesive tracks are arranged alternatingly relative to each other to relieve tension for the compensation of a length change of the adhesive tracks at the outflow side and the adhesive tracks at the inflow side in relation to the filter medium or the seal.

3. The filter element according to claim 2, wherein the elongate adhesive sections of the adhesive tracks at the inflow side and the first adhesive gaps of the adhesive tracks at the outflow side are arranged alternatingly along the unwinding of the folds.

4. The filter element according to claim 2, wherein the elongate adhesive sections of the adhesive tracks at the inflow side or the elongate adhesive sections of the adhesive tracks at the outflow side include elongate adhesive sections extending across fold tips of the folds.

5. The filter element according to claim 2, wherein the first adhesive gaps of the adhesive tracks at the inflow side or the first adhesive gaps of the adhesive tracks at the outflow side include first adhesive gaps extending across fold tips of the folds.

6. The filter element according to claim 2, wherein the folds at the inflow side include folds comprising fold bases exempt from the elongate adhesive sections at least in a rim region.

7. The filter element according to claim 2, wherein the folds comprise fold tips visible at the outflow side, wherein one or more of the first adhesive gaps are arranged on the fold tips visible at the outflow side.

8. The filter element according to claim 2, wherein, at the inflow side, the elongate adhesive sections include elongate adhesive sections arranged so as to extend into a fold base of the folds, respectively, and wherein, at the outflow side, the first adhesive gaps include first adhesive gaps arranged so as to extend into the fold base of the folds, respectively.

9. The filter element according to claim 2, wherein, at the inflow side, the elongate adhesive sections include elongate adhesive sections arranged so as to extend into a fold base of the folds, respectively, or wherein, at the outflow side, the first adhesive gaps include first adhesive gaps arranged so as to extend into the fold base of the folds, respectively.

10. The filter element according to claim 2, wherein, at the clean side outlet surface, the adhesive tracks at the outflow side comprise second adhesive gaps arranged at fold tips of the folds, wherein the second adhesive gaps are arranged in relation to the transverse direction such that, on neighboring ones of the adhesive tracks at the outflow side, the second adhesive gaps are arranged on different ones of the fold tips of the folds.

11. The filter element according to claim 2, wherein, in relation to the unwinding of the folds and viewed in the transverse direction, the elongate adhesive sections of neighboring ones of the adhesive tracks at the inflow side are arranged at a same level and wherein the first adhesive gaps of said neighboring ones of the adhesive tracks at the inflow side are arranged at a same level.

12. The filter element according to claim 2, wherein, in relation to the unwinding of the folds and viewed in the transverse direction, the elongate adhesive sections of neighboring ones of the adhesive tracks at the outflow side are arranged at a same level and wherein the first adhesive gaps of said neighboring ones of the adhesive tracks at the outflow side are arranged at a same level.

13. The filter element according to claim 2, wherein the elongate adhesive sections have a first length and the first adhesive gaps have a second length, wherein the first length and the second length are identical.

14. The filter element according to claim 2, wherein the adhesive tracks at the inflow side are arranged parallel and equidistantly to each other, and wherein the adhesive tracks at the outflow side are arranged parallel and equidistantly to each other.

15. The filter element according to claim 2, wherein the adhesive tracks at the inflow side and the adhesive tracks at the outflow side extend perpendicularly to fold tips of the folds, respectively.

16. A filter system for filtering a fluid, the filter system comprising:
a filter housing comprising at least one inlet for inflow of a fluid flow and at least one outlet for outflow of a purified fluid flow;
a filter element for filtering the fluid, the filter element arranged exchangeably in the filter housing between a raw side and a clean side;
wherein the filter element comprises:
a filter bellows comprising a zigzag-shaped folded filter medium with folds and further comprising a raw side inlet surface and a clean side outlet surface;
a reinforcement frame, wherein the filter bellows is arranged in the reinforcement frame;
at least one seal arranged circumferentially at least partially continuously at least in sections at an outer circumferential side of the filter medium at the raw side inlet surface or at the clean side outlet surface of the filter bellows;
elongate adhesive sections arranged along an unwinding of the folds of the filter medium in adhesive tracks at an inflow side of the folds and/or in adhesive tracks at an outflow side of the folds, wherein the adhesive tracks at the inflow side and the adhesive tracks at the outflow side are arranged offset relative to each other in a transverse direction of the filter medium;
wherein at least the adhesive tracks at the outflow side are configured, at least in sections, to relieve tension for a compensation of a length change of the adhesive tracks at the outflow side in relation to the filter medium or the seal.

17. The filter system according to claim 16, further comprising a cyclone preseparator arranged in the filter housing fluidically upstream in front of the filter element.

18. The filter system according to claim 16, further comprising a safety element arranged in the filter housing downstream behind the filter element.

19. The filter system according to claim 16, wherein the seal of the filter element, with the filter element installed as intended in the filter housing, separates the raw side from the clean side.

20. The filter system according to claim 16, wherein the filter element is an insertion filter element configured to be inserted into the filter housing transversely to a main flow axis of the fluid.
